(19) United States
(12) Patent Application Publication
(10) Pub. No.: US 2006/0204257 A1
(43) Pub. Date: Sep. 14, 2006

(54) Image forming apparatus

(75) Inventors: Hiroshi Kawano, Nara (JP); Shinji Imagawa, Nara (JP); Katsuhiro Nagayama, Nara (JP); Takashi Usui, Kyoto (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/372,933

(22) Filed: Mar. 9, 2006

(30) Foreign Application Priority Data
Mar. 9, 2005 (JP) 2005-65584

(51) Int. Cl. G03G 15/08

(52) U.S. Cl. 399/27

(57) ABSTRACT

In one embodiment, a pixel count portion that accumulates pixel count values for each pixel obtained by multiplying the input signal levels of a multilevel image by weighting coefficients, a toner consumption calculating portion that calculates toner consumption of each color from the pixel count sum value, an average toner consumption calculating portion that calculates average toner consumption per page based on the total amount of toner consumption and total number of pages printed subsequent to shipment, and a remaining toner calculating portion that calculates the amount of remaining toner from the total toner consumption based on the sum total of divided regions since the most recent time that a toner cartridge was exchanged, are provided, and a control portion executes a toner saving mode when the amount of remaining toner calculated by the remaining toner calculating portion reaches not more than a predetermined value set in advance.

### CROSS REFERENCE TO RELATED APPLICATIONS

This application claims priority under 35 U.S.C. §119(a) on Patent Application No. 2005-65584 filed in Japan on Mar. 9, 2005, the entire contents of which are hereby incorporated by reference.

### BACKGROUND OF THE INVENTION

1. Field of Invention

The present invention relates to image forming apparatuses such as copy machines, laser beam printers, facsimile apparatuses, or the like that use an electrophotographic system wherein image processing and correction processing of image information is digitally performed.

2. Related Art

Generally, with image processing in electrophotographic apparatuses such as digital copy machines, a digital image signal input by an image input apparatus such as a scanner is output as an output image signal after performing such digital signal processing as input signal processing, region separation processing, color correction processing, black generation processing, zoom variable power processing, and the like, then performing filter processing with a spatial filter, and also performing halftone correction processing.

FIG. 8 shows an image processing control block diagram for a conventional digital copy machine. In order to perform this control, this conventional digital copy machine includes an input signal processing portion 110, a region separation processing portion 120, a color correction/black generation processing portion 130, a zoom variable power processing portion 140, a spatial filter processing portion 150, a halftone correction processing portion 160, a pixel count portion 170, and a toner consumption calculating portion 180.

The image processing in this sort of digital copy machine is explained with reference to the flowchart in FIG. 9.

First, the digitally input image signal of an original read into a scanner or the like is input into the input signal processing portion 110, and preprocessing for the subsequent image processing, input gamma correction and conversion and the like in image adjustment are performed (Step S101, S102).

Next, this image signal is input into the region separation processing portion 120, regions such as text regions and halftone dot photograph regions are judged, and an identification signal showing the judgement (a region separation identification signal) is added to each region (Step S103). This region separation identification signal is used when, in the spatial filter processing portion 150, which is used for subsequent processing, performing processing differing for each region, for example, performing smoothing filter processing for halftone dot regions or performing edge emphasis filter processing for text regions, or in the halftone correction processing portion 160, which is also used for subsequent processing, when changing the halftone gamma properties to properties with clearer grayscale difference properties.

The color correction/black generation processing performed in the following color correction/black generation processing portion 130 (Step S104) is a necessary process when the apparatus is a color apparatus, and this processing converts the RGB image signal sent from the region separation processing portion 120 to a CMYK (yellow, magenta, cyan, black) image signal, which is the final output method.

After the zoom variable power processing in the zoom variable power processing portion 140 (Step S105), the image signal converted to CMYK is input to the spatial filter processing portion 150. In the spatial filter processing portion 150, a spatial filter is chosen from a spatial filter table in accordance with the region separation identification signal, the image mode setting state, and the like, and spatial filter processing is performed on the image signal converted to CMYK (Step S106). The spatial filter table is a table group of filter coefficients referred to when performing the spatial filter processing, wherein it is possible to select a desired table according to the circumstances.

Correction of the halftone gamma properties is performed (Step S107) in the next halftone correction processing portion 160, in order to correct the output properties at an engine portion.

Further, the image signal after halftone correction processing is input to the pixel count portion 170, and is accumulated by the counter while weighting each CMYK signal at every pixel. (Step S108). Then, the output image signal flows to the LSU or LED engine output (Step S110). In the toner consumption calculating portion 180, the toner consumption for each color is calculated from the pixel count sum value accumulated in the pixel count portion 170 (Step S109). The calculated toner consumption is used for accumulation of toner consumption data and determining when the toner is near the end of its life.

The engine of the type of digital copy machine described above is controlled such that a constant toner density and image output is output from the beginning until the end of toner life, by controlling the setting of process conditions such as developing bias values and the amount of exposure and toner density correction, in order to suppress aging of photosensitive bodies, developer, and the like.

FIG. 10 is a flowchart showing a simplified view of the toner density control processing, which is a control performed on the engine side. With this toner density control processing, the control value of the toner density sensor is determined from the values of the life counter and environment sensor (Step S111, S112), and ON/OFF of the toner refilling is controlled according to that value. That is, when the toner density is low (when judged YES in Step S113), the toner refill is turned ON, and controlled such that toner is refilled (Step S114). Thereby, the toner density is controlled such that it is always kept constant.

FIG. 11 is a flowchart showing a simplified view of the halftone gamma correction processing with the toner patch. With this halftone gamma correction processing, a toner patch is formed on a photosensitive body, a transfer belt, or the like with a halftone pattern (tone) according to a predetermined fixed input level (Step S121 to S123), and the quantity of light reflected from the toner patch is read by a reading apparatus such as an optical sensor (Step S124). Next, the sensor output level of the read toner patch is compared to the standard target level which is the target level, and the amount of correction is calculated (Step S125). Then, according to that calculated amount of correction, the current halftone gamma correction table is revised (Step S126), and thereby, controlled such that constant halftone gamma properties are always obtained.

Next, the calculation of the toner consumption noted above will be described in detail. The processing stated below is performed with respect to each CMYK color (each input CMYK signal).

The pixel count portion 170 performs a pixel count as described below for the multilevel image expressed by the input image signal. As shown in FIG. 8, the pixel count portion 170 is provided with a counting means 171, a weighting calculation means 172, a weighting coefficient table 173, and an accumulating means 174.

The counting means 171 counts each pixel of the input multilevel image (for example, multi-grade images such as 16-grade and 256-grade images). That is, input signal (grade) of each pixel constituting a multilevel image, for example, an input signal level such as 0 to 15 (in the case of a 16-grade image wherein the input signal level takes on the levels 0 to 15) is counted.

The weighting calculation means 172 performs weighting of each pixel when counting the pixels with the counting means 171. Specifically, the weighting calculation means 172 obtains a weighting coefficient corresponding to the input signal level of each pixel from the weighting coefficient table 173, and multiplies the obtained weighting coefficients by the input signal levels, thus obtaining a pixel count value. Respective weighting coefficients corresponding to a plurality of input signal levels are stored in the weighting coefficient table 173. In this way, in the pixel count portion 170, a pixel count value of each pixel is obtained by the counting means 171, the weighting calculation means 172, and the weighting coefficient table 173.

Summation of the pixel count values obtained for each pixel is performed by the accumulating means 174. That is, the accumulating means 174 accumulates the pixel count value for each pixel wherein a weighting coefficient has been multiplied by the input signal level by the weighting calculation means 172, over all pixels of the input multilevel image. In this way, based on the sum value of the pixel count calculated by the pixel count portion 170, the toner consumption calculating portion 180 calculates the toner consumption of the output image.

The weighting coefficients stored in the weighting coefficient table 173 are fixed values set in advance. An example of the weighting coefficient table 173 when the input signal takes on 16 levels from 0 to 15 is shown in the following Table 1.

TABLE 1
Conventional Art
Weighting Coefficient Table (Fixed)

| | Signal input level | Weighting coefficient |
|---|---|---|
| Area 1 | 0 to 4 | 0 |
| Area 2 | 5 to 8 | 1 |
| Area 3 | 9 to 12 | 3 |
| Area 4 | 13 to 15 | 4 |

Table 1 is divided into four areas (area 1 to area 4) corresponding to input signal levels for different amounts of toner consumption, and a weighting coefficient is set for each area. When counting pixels, weighting is performed with the weighting coefficient, which is divided into four areas, set corresponding to the respective input signal levels that take on the levels 0 to 15.

FIG. 12 shows the relationship between the weighting coefficient table signal input levels divided into the four areas (four divided regions) shown in Table 1 and the corresponding weighting coefficients. As shown in FIG. 12, the total area of the rectangular portions roughly matches the area of the curve showing the toner consumption properties, and therefore it is possible to predictably calculate the toner consumption from the pixel count sum value after weighting.

Image forming apparatuses have been proposed wherein toner thin layer nonuniformities are efficiently prevented when successively printing images which have an extremely small toner consumption rate (for example, see JP2002-287499A). Specifically, image forming apparatuses have been disclosed that have a pixel counter, a recording page counter, and a toner consumption means, wherein when a number of pixels not more than a predetermined value have been counted during a predetermined number of recording pages, during process control, along with performing a judgment that a consumption action is executed by the toner consumption means, the toner consumption means is created at the same time as creation of the process control toner patch when executing the consumption action.

However, in conventional electrophotographic apparatuses such as digital copy machines, there were the following problems.

As stated above, when performing the pixel count and calculating the toner consumption of the output image, a weighting coefficient table storing fixed weighting coefficients set in advance was used. However, when using this sort of weighting coefficient table, as shown in FIG. 12, the weighting coefficient determined from the weighting coefficient table for a particular input signal level may differ greatly from the value on the curve that shows the toner consumption properties for that input signal level. Therefore, there is the problem that the toner consumption cannot be accurately calculated from the sum value of the pixel count after weighting.

In this case, for example, as shown in FIG. 13, a method is conceivable wherein the difference between the actual toner consumption properties and the toner consumption calculated by the pixel count is decreased using a weighting coefficient table in which the weighted coefficients of the values that can be taken from the input signal levels, that is, the number of gradations of the input signal, are apportioned. However, when the toner consumption properties change from curve D shown by the solid line in FIG. 13 to the broken line shown by curve E due to individual difference or toner life, it is not possible to follow the change in the toner consumption properties by simply raising the number of gradations of the weighting coefficient table, and inaccurate toner consumption that differs from the actual toner consumption is calculated. When process control is performed based on inaccurate toner consumption, for example, when the calculated toner consumption is less than the actual toner consumption, the timing of the process control becomes too late, and it is not possible to keep the density of the output image constant.

Also, when the calculated toner consumption is inaccurate, the remaining toner calculated based on this inaccurate toner consumption also becomes inaccurate, and so the timing for transition to the toner saving mode and the timing of a display prompting that it is time to exchange the toner cartridge (for example, a display such as “soon out of toner”), displayed on the image forming apparatus, also become inaccurate. Ordinarily, this kind of display is displayed in the image forming apparatus with some leeway, such that even if this kind of display is shown, it is possible to perform toner saving and afterward print some number of pages. However, if the timing itself for transition to the toner saving mode, and for the display prompting that it is time to exchange the toner cartridge, is inaccurate, it may be possible for the toner supply to be exhausted immediately after the display. In this case, for example, if a toner cartridge for exchanging is not on hand, an order is placed to a manufacturer or the like after seeing this display, but it is possible that the toner supply will be exhausted before obtaining the ordered toner cartridge from the manufacturer or the like, and it will become impossible to print. Accordingly, it is desirable that the timing for transition to the toner saving mode, and for the display prompting that it is time to exchange the toner cartridge, is more accurate.

Also, even supposing that the timing for the display prompting that it is time to exchange the toner cartridge was accurate, the time period from the display prompting that it is time to exchange the toner cartridge to the time that the toner supply is actually exhausted varies greatly according to the operating conditions of the apparatus.

### SUMMARY OF THE INVENTION

The present invention was made in light of these circumstances, and it is an object thereof to provide an image forming apparatus in which it is possible to make transition to a toner saving mode, and to execute a display prompting that it is time to exchange the toner cartridge, with good timing based on the results of more accurately calculating the amount of remaining toner, and to provide an image forming apparatus in which it is possible to set the timing of the display prompting that it is time to exchange the toner cartridge based on the operating conditions of the apparatus.

The image forming apparatus of the present invention has a configuration in which a toner consumption calculating portion that obtains toner consumption by dividing an image into regions of a predetermined size, and weighting the total density or the total number of gradations of the divided regions; an average toner consumption calculating portion that calculates average toner consumption per page based on the total amount of toner consumption and total number of pages printed subsequent to shipment; and a remaining toner calculating portion that obtains the amount of remaining toner from the total toner consumption based on the sum total of the divided regions since the most recent time that a toner cartridge was exchanged, are provided; and a toner saving mode is executed when the amount of remaining toner reaches not more than a predetermined value that has been set in advance. At this time, a notification that transition will be made to the toner saving mode may be made by a notification portion (notification means). Here, notification that transition will be made to the toner saving mode specifically means execution of a display prompting that it is time to exchange the toner cartridge.

With the above configuration, because toner consumption is obtained by dividing an image into regions of a predetermined size, and weighting the total density or the total number of gradations of the divided regions, it is possible to accurately calculate toner consumption regardless of individual differences or toner life. Thus, an optimal timing can be set for transition to the toner saving mode, and for executing a display prompting that it is time to exchange the toner cartridge

Alternatively, the image forming apparatus of the present invention may have a configuration in which a toner consumption calculating portion that obtains toner consumption by dividing an image into regions of a predetermined size, and weighting the total density or the total number of gradations of the divided regions; an average toner consumption calculating portion that calculates average toner consumption per one page of paper based on the total amount of toner consumption and total number of pages printed subsequent to shipment; and a remaining toner calculating portion that obtains the amount of remaining toner from the total toner consumption based on the sum total of the divided regions since the most recent time that a toner cartridge was exchanged, are provided; and a toner saving mode is executed when the amount of remaining toner reaches not more than a value obtained by multiplying the average toner consumption by a predetermined number of pages that has been set in advance. At this time, a notification that transition will be made to the toner saving mode may be made by a notification portion (notification means). Specifically, a configuration in which a notification is made that transition will be made to the toner saving mode is given as an example, but the present invention is not limited to this configuration.

With the above configuration, because toner consumption is obtained by dividing an image into regions of a predetermined size, and weighting the total density or the total number of gradations of the divided regions, it is possible to accurately calculate toner consumption regardless of individual differences or toner life. Thus, an optimal timing can be set for transition to the toner saving mode, and for executing a display prompting that it is time to exchange the toner cartridge.

Here, for example, the predetermined number of pages may be set according to the operating conditions in the company or the like that uses this image forming apparatus. Specifically, when the operating conditions are such that the number of pages printed varies greatly from day to day, the timing of the display prompting that it is time to exchange the toner cartridge is set based on the number of pages printed. For example, when it takes at most one week until the toner cartridge is acquired, the number of pages printed during one week is calculated in advance from the total toner consumption, and that calculated number of pages is set as the predetermined number of pages. Thus, it is possible to perform printing for not less than the predetermined number of pages without worrying about exhaustion of the toner supply for not less than at least one week from execution of the display prompting that it is time to exchange the toner cartridge due to transition to the toner saving mode.

Alternatively, the image forming apparatus of the present invention may have a configuration in which a toner consumption calculating portion that obtains toner consumption by dividing an image into regions of a predetermined size, and weighting the total density or the total number of gradations of the divided regions; an average toner consumption calculating portion that calculates average toner consumption per page based on the total amount of toner consumption and total number of pages printed subsequent to shipment, and calculates average toner consumption per day of apparatus operation from the average toner consumption per page; and a remaining toner calculating portion that obtains the amount of remaining toner from the total toner consumption based on the sum total of the divided regions since the most recent time that a toner cartridge was exchanged, are provided; and a toner saving mode is executed when the amount of remaining toner reaches not more than a value obtained by multiplying the average toner consumption per day by a predetermined number of days that has been set in advance.

With the above configuration, because toner consumption is obtained by dividing an image into regions of a predetermined size, and weighting the total density or the total number of gradations of the divided regions, it is possible to accurately calculate toner consumption regardless of individual differences or toner life. Thus, an optimal timing can be set for transition to the toner saving mode, and for executing a display prompting that it is time to exchange the toner cartridge.

Here, the predetermined number of days may be set according to the operating conditions in the company or the like that uses this image forming apparatus. Specifically, when the operating conditions are such that the number of pages printed in one day is roughly constant, the timing of the display prompting that it is time to exchange the toner cartridge is set based on the number of days. For example, when it takes at most one week until the toner cartridge is acquired, this one week (seven days) is set as the predetermined number of days. Thus, it is possible to allow the apparatus to operate without stopping for a number of days not less than at least one week from execution of the display prompting that it is time to exchange the toner cartridge due to transition to the toner saving mode.

Also, in the image forming apparatus of the present invention, the toner consumption calculating portion may be provided with a weighting coefficient table in which the divided regions are expressed as pixel units of a multilevel image, and weighting coefficients corresponding to input signal levels that express the pixels of the multilevel image are stored in the weighting coefficient table; a rewriting portion that rewrites the weighting coefficients stored in the weighting coefficient table; a weighting calculation portion that, for each pixel of the multilevel image, obtains a weighting coefficient corresponding to the input signal level from the weighting coefficient table, and performs weighting of the input signal level based on the weighting coefficient; and an accumulating portion that accumulates calculation values that have been weighted by the weighting calculation portion; and the toner consumption calculating portion obtains the toner consumption based on the calculation values that have been accumulated by the accumulating portion.

With an image forming apparatus having this sort of configuration, because the weighting coefficients stored in the weighting coefficient table are rewritten, the weight of input signal levels based on the weighting coefficients of the weighting coefficient table can be matched to the actual toner consumption properties. That is, even when actual toner consumption properties have changed due to individual differences or toner life, it is possible to change the weighting coefficients stored in the weighting coefficient table so that they follow this change in toner consumption properties, and the calculation of toner consumption properties can be optimized. As a result, it is possible to accurately calculate toner consumption regardless of individual differences or toner life, and an optimal timing can be set for transition to the toner saving mode, and for executing a display prompting that it is time to exchange the toner cartridge. Thus, for example, when the time has come to exchange the toner cartridge, it is possible to ensure printing of a required number of pages until the toner cartridge for exchanging is acquired, and the apparatus can be allowed to operate without stopping until a toner cartridge is acquired.

### BRIEF DESCRIPTION OF THE DRAWINGS

FIG. 1 is a control block diagram showing the image processing in an image forming apparatus in which the present invention is applied.

FIG. 2 is a flowchart showing the processing of the toner consumption calculation for a single pixel.

FIG. 3 is a diagram showing the way in which the weighting coefficient table is rewritten.

FIG. 4 is a flowchart showing the rewrite processing of the weighting coefficient table.

FIGS. 5A and 5B show examples of a density detection patch in the image forming apparatus of the present invention.

FIG. 6 shows the configuration of the vicinity of a photosensitive drum during adjustment processing.

FIG. 7A shows an example of a gamma correction table used when ordinary printing is performed, and FIG. 7B shows an example of a gamma correction table used in a toner saving mode.

FIG. 8 is a control block diagram showing the image processing in a conventional image forming apparatus.

FIG. 9 is a flowchart showing the image processing in the conventional image forming apparatus.

FIG. 10 is a flowchart showing a simplified view of conventional toner density control processing.

FIG. 11 is a flowchart showing a simplified view of conventional halftone gamma correction processing using a toner patch.

FIG. 12 is a diagram showing the relationship between the signal input level of a conventional weighting coefficient table and corresponding weighting coefficients.

FIG. 13 is a diagram showing the relationship between the signal input level of another conventional weighting coefficient table and corresponding weighting coefficients.

### DESCRIPTION OF THE PREFERRED EMBODIMENTS

Hereinafter, embodiments of the present invention will be described with reference to the accompanying drawings, as an aid to understanding the present invention. The following embodiments are specific examples of the present invention, and are not of a nature limiting the technological scope of the present invention.

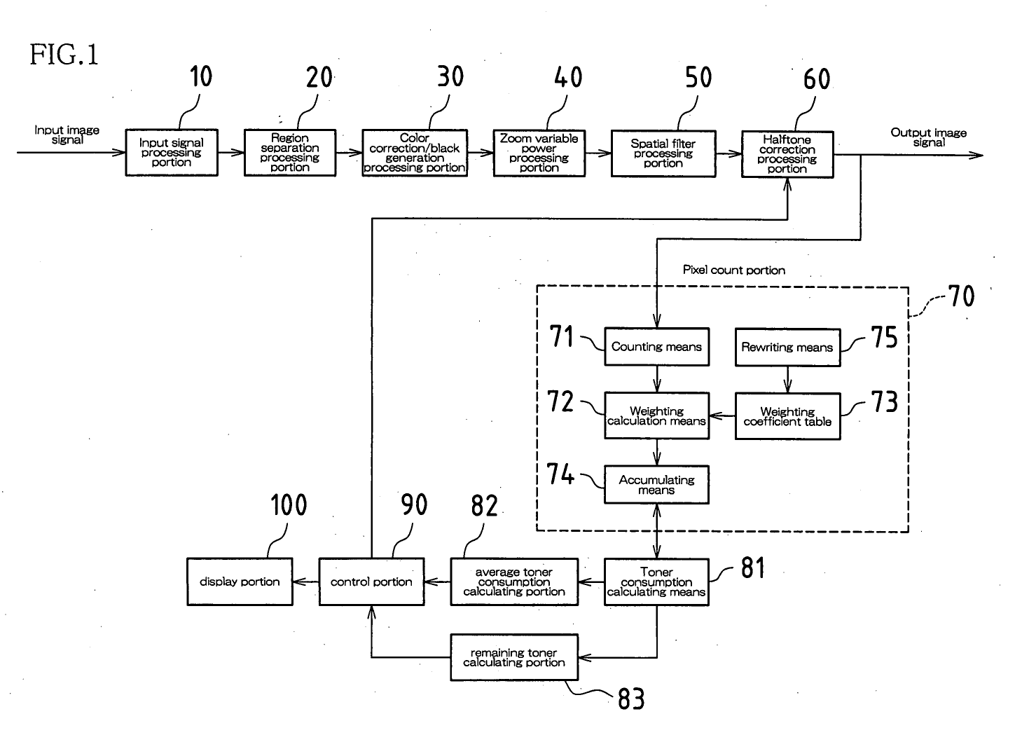

FIG. 1 is a control block diagram showing the image processing in an image forming apparatus (digital electrophotographic apparatus) in which the present invention is applied. As shown in FIG. 1, this digital electrophotographic apparatus includes an input signal processing portion 10, a region separation processing portion 20, a color correction/black generation processing portion 30, a zoom variable power processing portion 40, a spatial filter processing portion 50, a halftone correction processing portion 60, a pixel count portion 70, a toner consumption calculating portion 81, an average toner consumption calculating portion 82, a remaining toner calculating portion 83, a control portion 90, and a display portion 100. In the digital electrophotographic apparatus, a digitally input image signal of an original read by scanner or the like, not shown in the drawings, passes through the input signal processing portion 10, the region separation processing portion 20, the color correction/black generation processing portion 30, the zoom variable power processing portion 40, the spatial filter processing portion 50, and the halftone correction processing portion 60, and is output as an output image signal. The toner consumption calculating portion cited in the claims is configured in the present embodiment by the pixel count portion 70 and the toner consumption calculating portion 81.

The image processing in the digital electrophotographic apparatus configured in this manner will now be explained.

In the input signal processing portion 10, preprocessing for subsequent image processing, input gamma correction and conversion and the like in image adjustment are performed on the digitally input image signal of an original read by scanner or the like not shown in the drawings.

In the region separation processing portion 20, regions such as text regions and halftone dot photograph regions are judged, and an identification signal showing the judgement (a region separation identification signal) is added to each region. This region separation identification signal is used when, in the spatial filter processing portion 50, which is used for subsequent processing, performing processing differing for each region, for example, performing smoothing filter processing for halftone dot regions or performing edge emphasis filter processing for text regions, or in the halftone correction processing portion 60, which is also used for subsequent processing, when changing the halftone gamma properties to properties with clearer grayscale difference properties.

In the color correction/black generation processing portion 30, the RGB image signal sent from the region separation processing portion 20 is converted to a CMYK (yellow, magenta, cyan, black) image signal, which is the fmal output method. In the zoom variable power processing portion 40, variable power processing is performed on the CMYK image signal converted by the color correction/black generation processing portion 30.

In the spatial filter processing portion 50, a spatial filter is selected from the spatial filter table according to the previously mentioned region separation identification signal and the image mode setting state and the like, and spatial filter processing is performed on the image signal converted to CMYK. In the halftone correction processing portion 60, a correction of the halftone gamma properties is performed on the image signal on which spatial filter processing was performed. Then, the image signal after halftone correction processing in the halftone correction processing portion 60 is output as an output image signal.

In the pixel count portion 70, a pixel count is performed for the image signal after halftone correction processing with the halftone correction processing portion 60, while multiplying a weighting coefficient to each CMYK signal in pixel units.

In the toner consumption calculating portion 81, toner consumption is calculated for each color (CMYK) from the sum value of the pixel count. With the average toner consumption calculating portion 82, average toner consumption per page is calculated based on the total amount of toner consumption and total number of pages printed subsequent to shipment. With the remaining toner calculating portion 83, the amount of remaining toner is calculated from the total toner consumption based on the sum total of the divided regions since the most recent time that a toner cartridge was exchanged.

When the amount of remaining toner calculated by the remaining toner calculating portion 83 reaches not more than a predetermined value that has been set in advance, the control portion 90 controls the halftone correction processing portion 60 and executes the toner saving mode.

First, the processing that calculates toner consumption in the digital electrophotographic apparatus with the above configuration is explained in detail. The process referred to below is performed for each CMYK color (each input CMYK signal).

The pixel count portion 70 performs a pixel count as described below for a multilevel image expressed by the input image signal. As shown in FIG. 1, the pixel count portion 70 is provided with a counting means 71, a weighting calculation means 72, a weighting coefficient table 73, an accumulating means 74, and a rewriting means 75.

The counting means 71 counts each pixel of the input multilevel image (for example, 16-grade and 256-grade multilevel images). That is, it counts the input signal (grade) of each pixel constituting the multilevel image, for example, it counts an input signal level such as 0 to 15 (in the case of a 16-grade image, in which the input signal level takes on the levels 0 to 15).

The weighting calculation means 72 performs weighting of each pixel when the pixels are counted by the counting means 71. Specifically, the weighting calculation means 72 obtains a weighting coefficient corresponding to the input signal level of each pixel from the weighting coefficient table 73, and multiplies the obtained weighting coefficient by the input signal levels. Respective weighting coefficients corresponding to a plurality of input signal levels are stored in the weighting coefficient table 73. In this way, in the pixel count portion 70, a pixel count value of each pixel is obtained by the counting means 71, the weighting calculation means 72, and the weighting coefficient table 73.

Then, summation of the pixel count values obtained for each pixel is performed by the accumulating means 74. That is, the accumulating means 74 accumulates the pixel count value of each pixel having a weighting coefficient multiplied by the input signal level by the weighting calculation means 72, for all the pixels of the input multilevel image. A rewriting means 75, as described below, rewrites the weighting coefficient table 73. The toner consumption calculating portion 81 calculates the toner consumption of the output image, based on the sum value of the pixel count values calculated by accumulated by the accumulating means 74.

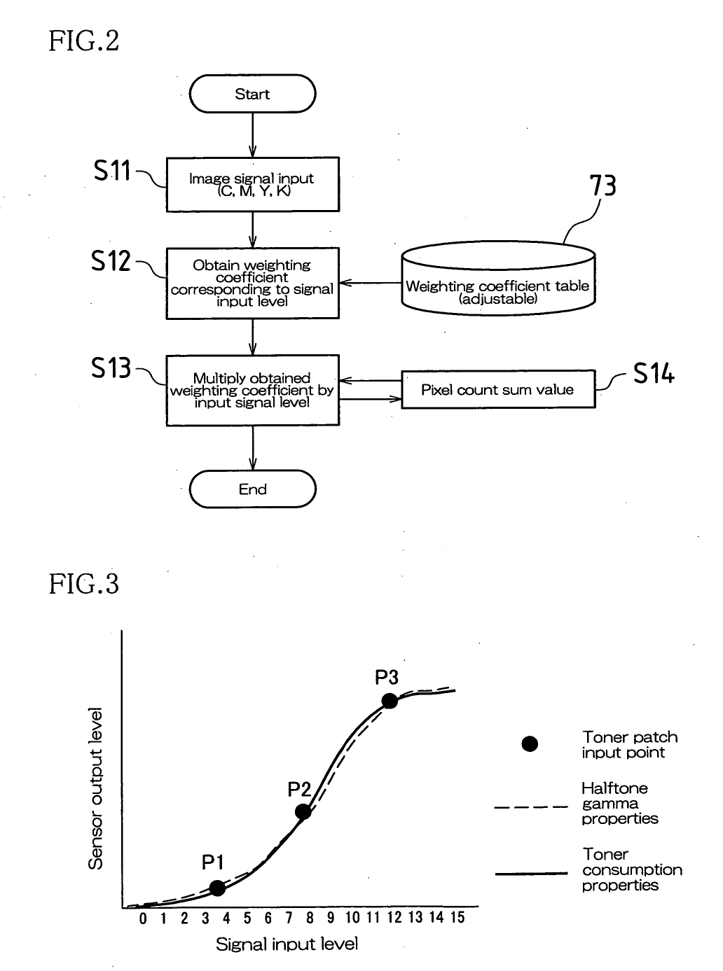

The toner consumption calculation for a single pixel is explained using FIG. 2. As shown in FIG. 2, when the signal for a single pixel that is part of the multilevel image is input into the pixel count portion 70 (Step S11), the input signal level is counted by the counting means 71. Next, a weighting coefficient corresponding to the input signal level is obtained by the weighting calculation means 72 from the weighting coefficient table 73 (Step S12), this weighting coefficient is multiplied by the pixel count value of the input signal level from the counting means 71, and a pixel count value for a single pixel is obtained (Step S13). The pixel count value for a single pixel obtained in this way corresponds to the toner consumption of a single pixel. The pixel count values calculated for each single pixel are sequentially accumulated by the accumulating means 74, and saved as a pixel count sum value (Step S14). The pixel count sum value is a sum of pixel count values for all of the input pixels, and based on this pixel count sum value, the toner consumption of the output image can be calculated by the toner consumption calculating portion 81.

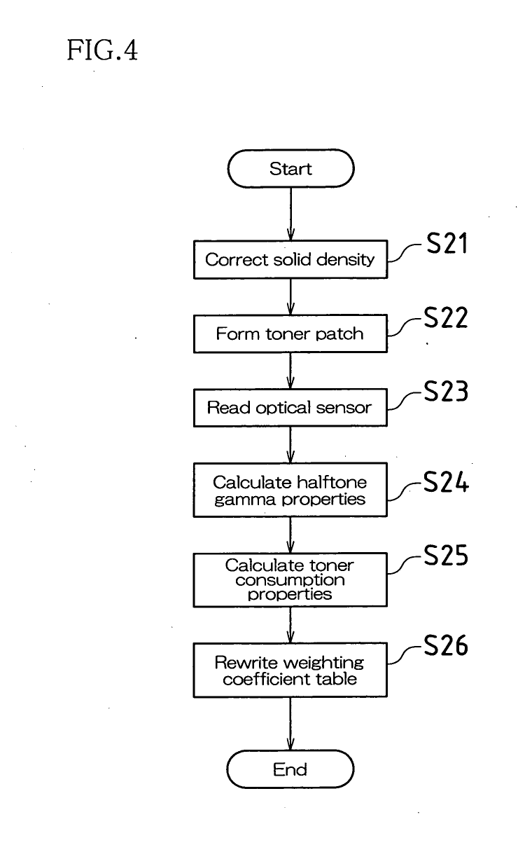

Next, the rewriting of the weighting coefficient table 73 is explained using FIGS. 3 and 4. The weighting coefficients stored in the weighting coefficient table 73 are adjustable, unlike in the conventional technology, and can be rewritten by the rewriting means 75. One example of the weighting coefficient table 73, for the case of a 16-level input signal level that takes on input signal levels 0 to 15, is shown in the following Table 2.

TABLE 2
Weighting Coefficient Table (Adjustable)

| Signal input level | Weighting coefficient |
|---|---|
| 0 | X0 |
| 1 | X1 |
| 2 | X2 |
| 3 | X3 |
| 4 | X4 |
| 5 | X5 |
| 6 | X6 |
| 7 | X7 |
| 8 | X8 |
| 9 | X9 |
| 10 | X10 |
| 11 | X11 |
| 12 | X12 |
| 13 | X13 |
| 14 | X14 |
| 15 | X15 |

In Table 2, the weighting coefficients (X0 to X15) corresponding to the input signal levels 0 to 15 are each adjustable. The weighting coefficients X0 to X15 are rewritten as follows by the rewriting means 75.

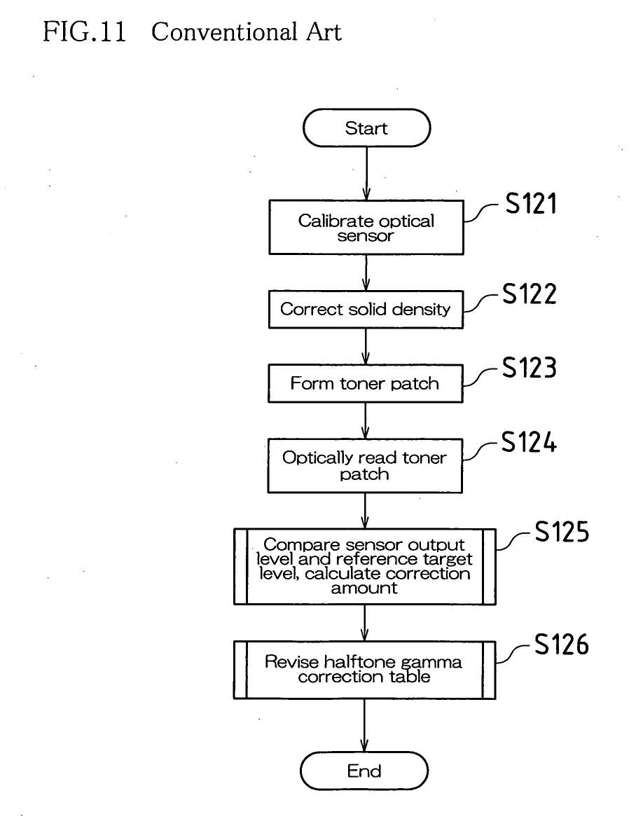

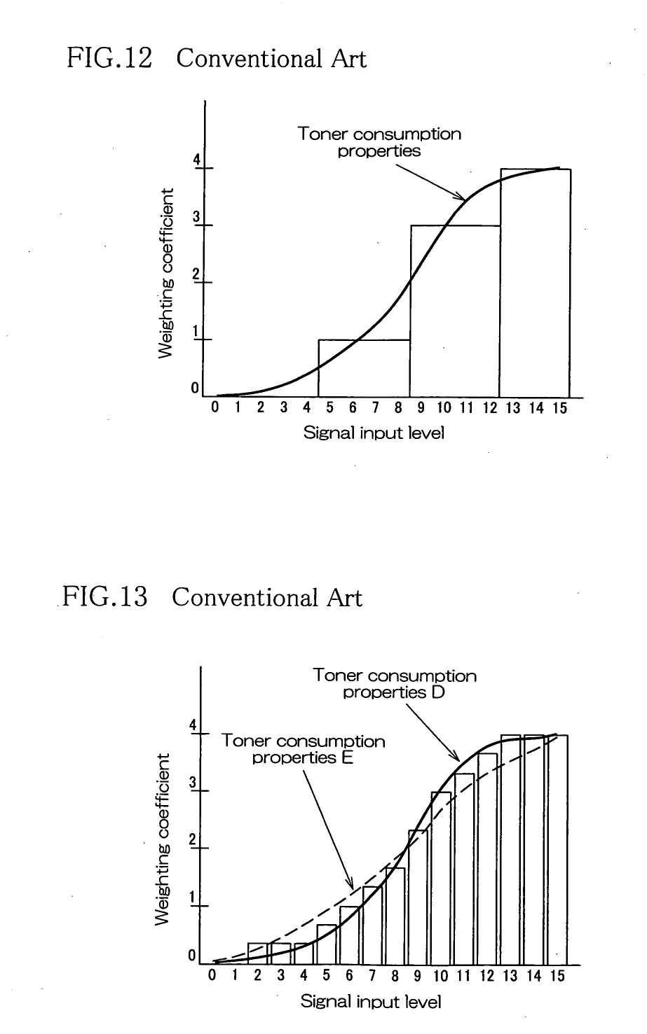

First, after the solid toner density has been corrected (Step S21), a plurality of toner patches having mutually differing tones, as shown by points P1, P2, and P3 in FIG. 3, are formed on the photosensitive body or transfer belt (Step S22). That is, halftone toner patches for a plurality of input points set in advance are formed on the photosensitive body or transfer belt. Then, the amount of reflected light of those toner patches is read by a reading means such as an optical sensor (Step S23). In FIG. 3, the vertical axis is the sensor output of the reading means such as an optical sensor, and the horizontal axis is the signal input level (grade). There is no particular limitation to the number of input points, but it is preferable to have at least three points. The procedure of above Steps S21 to S23 is similar to Steps S122 to S124 in the halftone gamma correction processing shown in FIG. 11, stated above in the section explaining the related art, and so the following procedure may also be performed, using the results of this halftone gamma correction processing.

Next, based on the sensor output of toner patches for a plurality of input points, the halftone gamma properties as shown by the broken line in FIG. 3 are calculated (Step S24). Based on the calculated halftone gamma properties, the toner consumption properties for the signal input levels as shown by the solid line in FIG. 3 are calculated (Step S25). The weighting coefficients are determined based on the toner consumption properties calculated in this manner, and the weighting coefficients stored in the weighting coefficient table 73 are rewritten to the determined weighting (Step S26). In the case of Table 2, the weighting coefficients X0 to X15 corresponding to the input signal levels 0 to 15 are rewritten according to the toner consumption properties.

In this way, a pixel count of the input multilevel image is performed in the pixel count portion 70 using the weighting coefficients rewritten by the rewriting means 75, and the toner consumption of the output image is calculated by the toner consumption calculating portion 81.

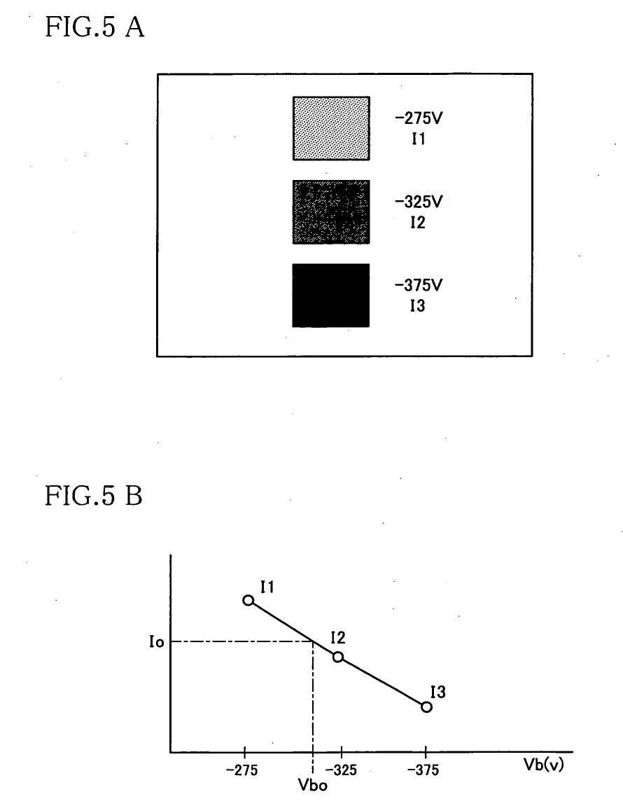

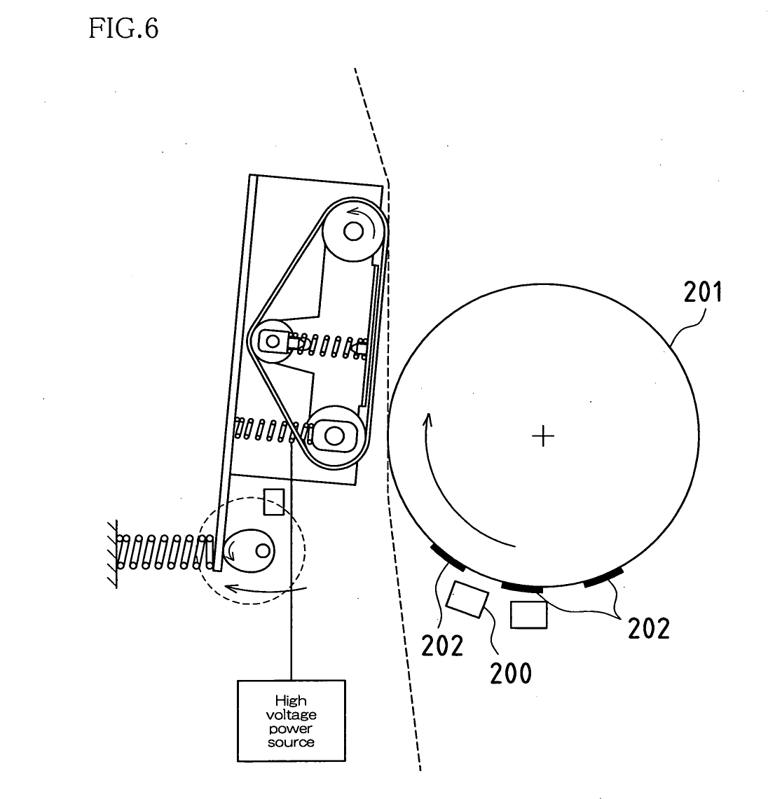

In this way, even when actual toner consumption properties have changed due to individual differences or toner life, it is possible to follow the changes in toner properties and rewrite the weighting coefficient table 73, and the calculation of toner consumption properties can be optimized. As a result, toner consumption can be accurately calculated irrespective of individual differences or toner life. That is, it is possible to hold the discrepancy between the actual toner consumption and the toner consumption calculated using the weighting coefficient table 73 rewritten by the rewriting means 75 to a low level. When the sum toner consumption obtained by the method described above is a predetermined value, the process control described below is executed. For example, as shown in FIG. 5A, with image forming conditions kept at grid bias −500 V, laser power Po=0.43 mW, and laser PWM duty ratio 100%, developing bias Vb is changed to equal −275 V, −325 V, and −375 V, and as shown in FIG. 6, three 20 mm×20 mm density detection patches 202 are formed on the circumferential face of a photosensitive drum 201.

When detecting the formed density detection patches 202, one density detection patch 202 is read by a patch image detector 200 configured from a reflex optical sensor, sampling is performed for about ten-odd points, and an average is calculated with nearly maximum and nearly minimum values removed. The output of the patch image detector 200 corresponding to the density of the three density detection patches 202 is respectively made I1, I2, and I3.

As shown in FIG. 5B, a regression curve is obtained for the density of the developing bias, and from this regression curve a developing bias Vbo is obtained, which will be a predetermined density I0. Here, the predetermined density I0 is the density that should be obtained when the laser PWM duty ratio has been set to 80%. That is, the developing bias Vbo is a value of the developing bias that makes it possible to obtain the desired density by adjusting the amount of exposure. When this developing bias Vbo is obtained, the present developing bias value changes to the developing bias Vbo.

Each time image formation is performed subsequent to product shipment, the average toner consumption calculating portion 82 totals the output image toner consumption calculated in the toner consumption calculating portion 81 in the above manner and the number of pages printed. Based on that total toner consumption and total number of pages printed, the average toner consumption calculating portion 82 calculates average toner consumption per page. The average toner consumption is obtained by simply dividing the total toner consumption by the total number of pages printed.

On the other hand, the remaining toner calculating portion 83 obtains the amount of remaining toner from the total toner consumption since the most recent time that a toner cartridge was exchanged (also including product shipment).

Following is a description of the processing that switches to the toner saving mode in the control portion 90.

First is a description of the toner saving mode.

As for the specific method of the toner saving mode, various methods have been proposed in the conventional technology, and in the present invention as well, it is possible to perform toner saving by using such a conventional method, but here, an example is described in which toner saving is performed by changing the gamma correction table used when correcting the halftone gamma properties with the halftone correction processing portion 60.

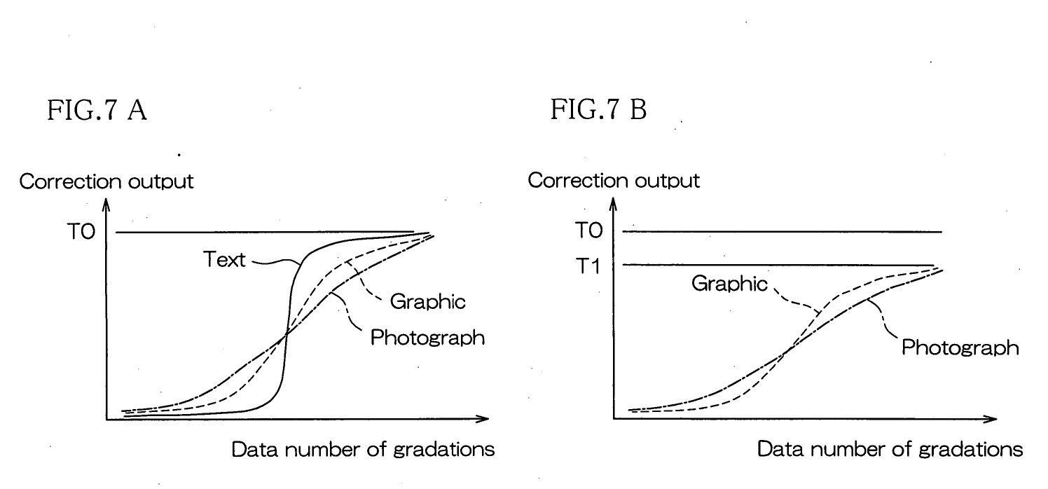

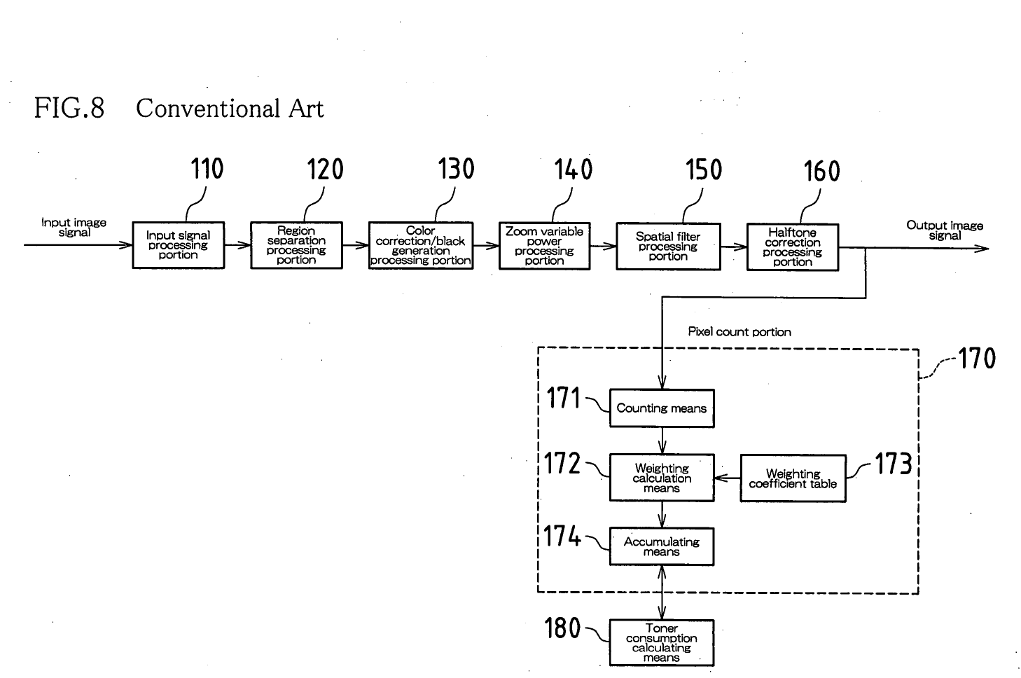

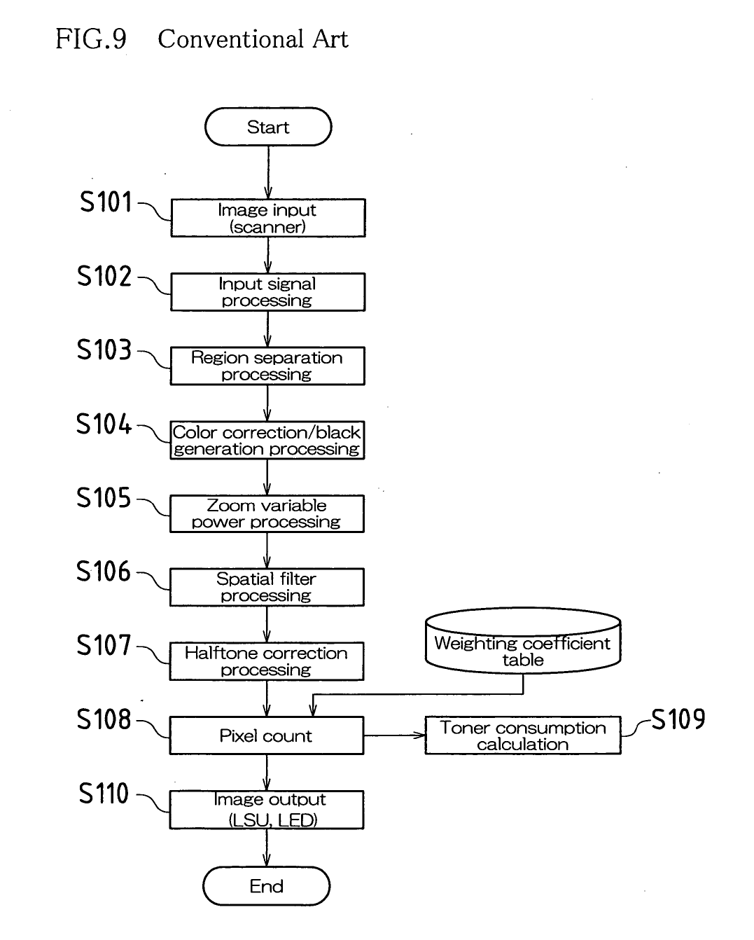

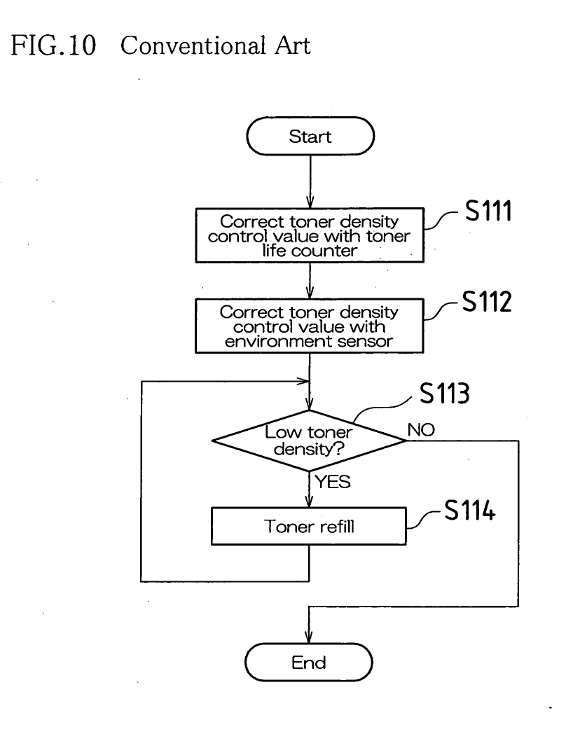

FIGS. 7A and 7B show examples of a gamma correction table, and FIG. 7A shows a gamma correction table used when ordinary printing is performed. On the other hand, FIG. 7B shows the gamma correction table used in the toner saving mode in the present embodiment, and comparing these two tables, the table in FIG. 7B is one with which, in the toner saving mode, by suppressing correction output levels as a whole, printing is performed with brightness and saturation suppressed. Particularly, with respect to photographs and graphics, by further suppressing the correction output levels of high-density areas with high gradation (specifically, suppressing a correction output level T0 when performing ordinary printing to T1), a reduction in the toner consumption as a whole is achieved.

Based on the amount of remaining toner calculated in the remaining toner calculating portion 83 and the average toner consumption calculated in the average toner consumption calculating portion 82, the control portion 90 executes the above toner saving mode when the amount of remaining toner reaches not more than a predetermined value that has been set in advance. Also, when executing the toner saving mode, the control portion 90 displays a message on the display portion 100 notifying that transition will be made to the toner saving mode. Specifically, the control portion 90 displays a message prompting that it is time to exchange the toner cartridge (for example, a display such as “soon out of toner”). As the notifying means that makes a notification that transition will be made to the toner saving mode, other than a display according to this sort of method, for example, notification by turning on or blinking a lamp or the like, or notification by an electronic sound or the like, are possible. Notification can also be made by a combination of these methods.

Here, an example of a case in which the above predetermined values are specifically set will be described.

### EXAMPLE 1

In Example 1, the control portion 90 executes the toner saving mode and performs the display prompting that it is time to exchange the toner cartridge when, based on the amount of remaining toner calculated in the remaining toner calculating portion 83 and the average toner consumption calculated in the average toner consumption calculating portion 82, the amount of remaining toner reaches not more than a value obtained by multiplying the average toner consumption by the predetermined number of pages set in advance.

Here, for example, the predetermined number of pages is set according to the operating conditions in the company or the like that uses this image forming apparatus. Specifically, when the operating conditions are such that the number of pages printed varies greatly from day to day, the predetermined number of pages is set based on the number of pages printed.

For example, when it takes at most one week until the toner cartridge for exchanging is acquired, the number of pages actually printed during one week in the company or the like is calculated in advance from the total number of pages printed totaled with the average toner consumption calculating portion 82. Here, the calculation of the total number of pages printed in one week may be performed using the most recent total number of pages printed in one week as-is, or using, for example, the highest total number of pages printed in one week during the last several weeks, or using a value obtained by dividing the total number of pages printed in the last several weeks by that number of weeks (i.e., the average total number of pages printed per week for the last several weeks). The total number of pages printed calculated in this manner is set as the predetermined number of pages. The method of calculating the total number of pages set as the predetermined number of pages is not limited to the methods above, and that calculation method itself is stored in advance as a program in the control portion 90. However, a user may select the calculation method as desired according to the operating conditions in the company or the like that uses this image forming apparatus. As the selection method, a configuration may be adopted in which, for example, a selection mode is displayed on a screen with a desired button operation of an unshown operating panel provided in the apparatus main body, and the selection can be made on that display screen.

That is, the control portion 90 executes the toner saving mode and performs the display prompting that it is time to exchange the toner cartridge when the amount of remaining toner reaches not more than a value obtained by multiplying the average toner consumption by the predetermined number of pages set in advance (the total number of pages printed). Thus, it is possible to perform printing for not less than the predetermined number of pages without worrying about exhaustion of the toner supply for not less than at least one week from execution of the display prompting that it is time to exchange the toner cartridge.

### EXAMPLE 2

In Example 2, the control portion 90 executes the toner saving mode and performs the display prompting that it is time to exchange the toner cartridge when, based on the amount of remaining toner calculated in the remaining toner calculating portion 83 and the average toner consumption calculated in the average toner consumption calculating portion 82, the amount of remaining toner reaches not more than a value obtained by multiplying the average toner consumption per day by the predetermined number of days set in advance.

Here, for example, the predetermined number of days is set according to the operating conditions in the company or the like that uses this image forming apparatus. Specifically, when the operating conditions are such that the number of pages printed in one day is roughly constant, because the amount of toner consumption in one day is also roughly constant, the predetermined number of days is set based on a number of days obtained based on the amount of toner consumption in one day.

For example, when it takes at most one week until the toner cartridge is acquired, this one week (seven days) is set as the predetermined number of days. In a company or the like using this image forming apparatus, a user may set this predetermined number of days as desired according to operating conditions. As the method of setting the predetermined number of days, a configuration may be adopted in which, for example, a setting mode is displayed on a screen with a desired button operation of an unshown operating panel provided in the apparatus main body, and the predetermined number of days can be set by inputting the number of days on that display screen.

Thus, it is possible to allow the apparatus to operate without stopping for a number of days not less than at least one week from execution of the display prompting that it is time to exchange the toner cartridge.

Also, in the present embodiment, as the above predetermined values, both the predetermined number of pages in above Example 1 and the predetermined number of days in above Example 2 may be selectable by a user. In this case the user's options and ease of use will increase.

The present invention may be embodied in various other forms without departing from the gist or essential characteristics thereof The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An image forming apparatus comprising:
a toner consumption calculating portion that obtains toner consumption by dividing an image into regions of a predetermined size, and weighting the total density or the total number of gradations of the divided regions;
an average toner consumption calculating portion that calculates average toner consumption per page based on the total amount of toner consumption and total number of pages printed subsequent to shipment; and
a remaining toner calculating portion that obtains the amount of remaining toner from the total toner consumption based on the sum total of the divided regions since the most recent time that a toner cartridge was exchanged;
wherein a toner saving mode is executed when the amount of remaining toner reaches not more than a predetermined value that has been set in advance.

2. An image forming apparatus comprising:
a toner consumption calculating portion that obtains toner consumption by dividing an image into regions of a predetermined size, and weighting the total density or the total number of gradations of the divided regions;
an average toner consumption calculating portion that calculates average toner consumption per one page of paper based on the total amount of toner consumption and total number of pages printed subsequent to shipment; and
a remaining toner calculating portion that obtains the amount of remaining toner from the total toner consumption based on the sum total of the divided regions since the most recent time that a toner cartridge was exchanged;
wherein a toner saving mode is executed when the amount of remaining toner reaches not more than a value obtained by multiplying the average toner consumption by a predetermined number of pages that has been set in advance.

3. An image forming apparatus comprising:
a toner consumption calculating portion that obtains toner consumption by dividing an image into regions of a predetermined size, and weighting the total density or the total number of gradations of the divided regions;
an average toner consumption calculating portion that calculates average toner consumption per page based on the total amount of toner consumption and total number of pages printed subsequent to shipment, and calculates average toner consumption per day of apparatus operation from the average toner consumption per page; and
a remaining toner calculating portion that obtains the amount of remaining toner from the total toner consumption based on the sum total of the divided regions since the most recent time that a toner cartridge was exchanged;
wherein a toner saving mode is executed when the amount of remaining toner reaches not more than a value obtained by multiplying the average toner consumption per day by a predetermined number of days that has been set in advance.

4. The image forming apparatus according to any one of claims 1 to 3,
wherein the toner consumption calculating portion comprises:
a weighting coefficient table in which the divided regions are expressed as pixel units of a multilevel image, and weighting coefficients corresponding to input signal levels that express the pixels of the multilevel image are stored in the weighting coefficient table;
a rewriting portion that rewrites the weighting coefficients stored in the weighting coefficient table;
a weighting calculation portion that, for each pixel of the multilevel image, obtains a weighting coefficient corresponding to the input signal level from the weighting coefficient table, and performs weighting of the input signal level based on the weighting coefficient; and
an accumulating portion that accumulates calculation values that have been weighted by the weighting calculation portion;
wherein the toner consumption calculating portion obtains the toner consumption based on the calculation values that have been accumulated by the accumulating portion.

5. The image forming apparatus according to any one of claims 1 to 3, further comprising a notification portion that notifies that transition will be made to the toner saving mode.

6. The image forming apparatus according to claim 4, further comprising a notification portion that notifies that transition will be made to the toner saving mode.
